(19) United States
(12) Patent Application Publication
(10) Pub. No.: US 2026/0350498 A1
(43) Pub. Date: Nov. 5, 2026

(54) WORKSHOP SCHEDULING METHOD AND DEVICE CONSIDERING SKILL LEVELS AND FATIGUE DEGREES OF WORKERS

(71) Applicant: ZHEJIANG UNIVERSITY, Hangzhou (CN)

(72) Inventors: Baicun WANG, Hangzhou (CN); Kailing ZHU, Hangzhou (CN); Yingxue HE, Hangzhou (CN); Haibo XIE, Hangzhou (CN); Huayong YANG, Hangzhou (CN)

(21) Appl. No.: 19/486,200

(22) PCT Filed: Dec. 17, 2024
(86) PCT No.: PCT/CN2024/140126

§ 371 Date: Nov. 20, 2025

(30) Foreign Application Priority Data
May 11, 2024 (CN) 202410584458.X

(51) Int. Cl. G06Q 10/0631; G06Q 10/04

(52) U.S. Cl. CPC G06Q 10/063112; G06Q 10/04

(57) ABSTRACT

The present disclosure provides a workshop scheduling method and device considering skill levels and fatigue degrees of workers. The method provided by the present disclosure includes: constructing a production scheduling example based on a workshop scheduling model according to production order data, worker data and workshop equipment data; determining state parameters of a workshop for each step of scheduling operation based on the production scheduling example and a scheduling Gantt chart; determining a search strategy used for this step of scheduling operation; randomly selecting one scheduling rule as a current scheduling rule from a plurality of scheduling rules when the search strategy is random search; or inputting the state parameters of the workshop into a scheduling network when the search strategy is network prediction.

### CROSS REFERENCE OF RELATED APPLICATION

The present application is a 371 of international Application PCT/CN2024/140126, filed Dec. 17, 2024, which claims priority to Chinese Patent Application No. 202410584458.X filed on May 11, 2023. The contents of the applications are incorporated herein by reference in their entireties.

### TECHNICAL FIELD

The present disclosure relates to the technical field of workshop scheduling, and in particular, to a workshop scheduling method and device considering skill levels and fatigue degrees of workers.

### BACKGROUND

With the diversification and individualization of market demands, manufacturing enterprises are facing increasingly complex challenges in the process of production. In a workshop, production resources such as equipment, manpower and raw materials are limited, which leads to tight production schedules and increased downtime and waiting time in the process of production. This situation may result in a decline in production efficiency and the emergence of problems. Therefore, manufacturing enterprises need to reasonably allocate limited production resources through workshop scheduling to improve the production efficiency.

### SUMMARY

In view of the above, the present disclosure provides a workshop scheduling method and device considering skill levels and fatigue degrees of workers, aiming to reasonably allocate limited production resources through workshop scheduling to improve the production efficiency.

Specifically, the present disclosure is implemented by the following technical solutions:

A first aspect of the present disclosure provides a workshop scheduling method considering skill levels and fatigue degrees of workers, including:
constructing a workshop scheduling model, and constructing a production scheduling example based on the workshop scheduling model according to production order data, worker data and workshop equipment data, where the workshop scheduling model is a workshop scheduling model considering the skill levels and fatigue degrees of the workers; and
solving the production scheduling example using a scheduling algorithm to obtain a scheduling solution of the production scheduling example.

Solving the production scheduling example using the scheduling algorithm includes:
determining state parameters of a workshop at the current moment for each step of scheduling operation based on the production scheduling example and a scheduling Gantt chart at the current moment;
determining a search strategy used for this step of scheduling operation;
randomly selecting one scheduling rule as a current scheduling rule from a plurality of preset scheduling rules when the search strategy is random search; or inputting the current state parameters of the workshop into a scheduling network when the search strategy is network prediction, so that the scheduling network determines a reward value of each of the plurality of scheduling rules corresponding to the state parameters and takes the scheduling rule with the maximum reward value as a current scheduling rule;
determining a scheduling group corresponding to this step of scheduling operation according to the current scheduling rule, where the scheduling group is a combination of a workpiece, a machine and a worker; and
decoding the scheduling group to the scheduling Gantt chart using a greedy decoding mode.

A second aspect of the present disclosure provides a workshop scheduling device considering skill levels and fatigue degrees of workers. The device includes a construction module and a solving module, where
the construction module is configured for constructing a workshop scheduling model and constructing a production scheduling example based on the workshop scheduling model according to production order data, worker data and workshop equipment data, where the workshop scheduling model is a workshop scheduling model considering the skill levels and fatigue degrees of the workers; and
the solving module is configured for solving the production scheduling example using a scheduling algorithm to obtain a scheduling solution of the production scheduling example.

Solving the production scheduling example using the scheduling algorithm includes:
determining state parameters of a workshop at the current moment for each step of scheduling operation based on the production scheduling example and a scheduling Gantt chart at the current moment;
determining a search strategy used for this step of scheduling operation;
randomly selecting one scheduling rule as a current scheduling rule from a plurality of preset scheduling rules when the search strategy is random search; or inputting the current state parameters of the workshop into a scheduling network when the search strategy is network prediction, so that the scheduling network determines a reward value of each of the plurality of scheduling rules corresponding to the state parameters and takes the scheduling rule with the maximum reward value as a current scheduling rule;
determining a scheduling group corresponding to this step of scheduling operation according to the current scheduling rule, where the scheduled group is a combination of a workpiece, a machine and a worker; and
decoding the scheduling group into the scheduling Gantt chart using a greedy decoding mode.

A third aspect of the present disclosure provides workshop scheduling equipment considering skill levels and fatigue degrees of workers, including a memory, a processor, and a computer program stored in the memory and capable of running on the processor. The program, when executed by the processor, implements the steps of the any one of the methods provided by the first aspect of the present disclosure.

A fourth aspect of the present disclosure provides a computer-readable storage medium storing a computer program, where the program, when executed by a processor, implements the steps of any one of the methods provided by the first aspect of the present disclosure.

According to the workshop scheduling method and device considering skill levels and fatigue degrees of workers provided by the present disclosure, in a first aspect, by constructing the workshop scheduling model and the production scheduling example and solving the production scheduling example through the workshop scheduling model, workshop scheduling is achieved, thereby reasonably allocating effective production resources, optimizing the production process and improving the production efficiency of a workshop. In a second aspect, the skill levels and fatigue degrees of the workers and the carbon emissions of a system are considered during construction of the workshop scheduling model, aiming to reduce the carbon emissions from production while maintaining the production fairness of the workers, thereby helping manufacturing enterprises to establish a more scientific and sustainable workshop scheduling model, improving the production efficiency and reducing carbon emissions, which is of great significance for the sustainable development of enterprises. In a third aspect, solving the production scheduling example using different search strategies improves the generalization of scheduling solution, enhances the production benefits of the workshop, and achieves real-time scheduling solving, greatly increasing the solving speed of scheduling solution, and improving the scheduling speed.

### BRIEF DESCRIPTION OF THE DRAWINGS

FIG. 1 is a flowchart of a first embodiment of a workshop scheduling method considering skill levels and fatigue degrees of workers provided by the present disclosure.

FIG. 2 is a schematic diagram of a workshop scheduling model according to an example of the present disclosure.

FIG. 3 is a flowchart of solving a production scheduling example based on a scheduling algorithm according to an example of the present disclosure.

FIG. 4 is a schematic diagram of a scheduling Gantt chart according to an example of the present disclosure.

FIG. 5 is a flowchart of a second embodiment of the workshop scheduling method considering skill levels and fatigue degrees of workers according to an example of the present disclosure.

FIG. 6 is a schematic diagram illustrating the implementation principle of greedy decoding according to an example of the present disclosure.

FIG. 7 is a flowchart of a third embodiment of the workshop scheduling method considering skill levels and fatigue degrees of workers provided by the present disclosure.

FIG. 8 is a schematic diagram illustrating the implementation principle of training of a scheduling network according to an example of the present disclosure.

FIG. 9 is a hardware structure diagram of workshop scheduling equipment considering skill levels and fatigue degrees of workers where a workshop scheduling device considering skill levels and fatigue degrees of workers provided by the present disclosure is located.

FIG. 10 is a schematic structural diagram of a first embodiment of the workshop scheduling device considering skill levels and fatigue degrees of workers provided by the present disclosure.

### DETAILED DESCRIPTION OF THE EMBODIMENTS

Embodiments will be illustrated in details herein, with examples illustrated in the accompanying drawings. In the following description when involving the accompanying drawings, the same numerals in different accompanying drawings represent the same or similar elements, unless otherwise indicated. The implementations described in the following embodiments do not represent all implementations consistent with the present disclosure.

The terms used in the present disclosure are merely for the purpose of describing the specific embodiments rather than limiting the present disclosure. The singular forms, “a/an,” “the” and “this,” used in the present disclosure are also intended to include plural forms, unless other meanings are clearly indicated in contexts. It should also be understood that the term “and/or” used herein refers to and includes any or all possible combinations of one or more associated listed items.

It should be understood that although terms such as first, second and third may be adopted in the present disclosure to describe various information, and such information should not be limited to these terms. These terms are merely used to distinguish the same type of information from one another. For example, without departing from the scope of the present disclosure, first information may also be referred to as second information, and similarly, the second information may also be referred to as the first information. Depending on the context, the word “if” used herein may be interpreted as “when,” or “upon,” or in response to determining”.

Specific embodiments are given below to introduce the technical solutions of the present disclosure.

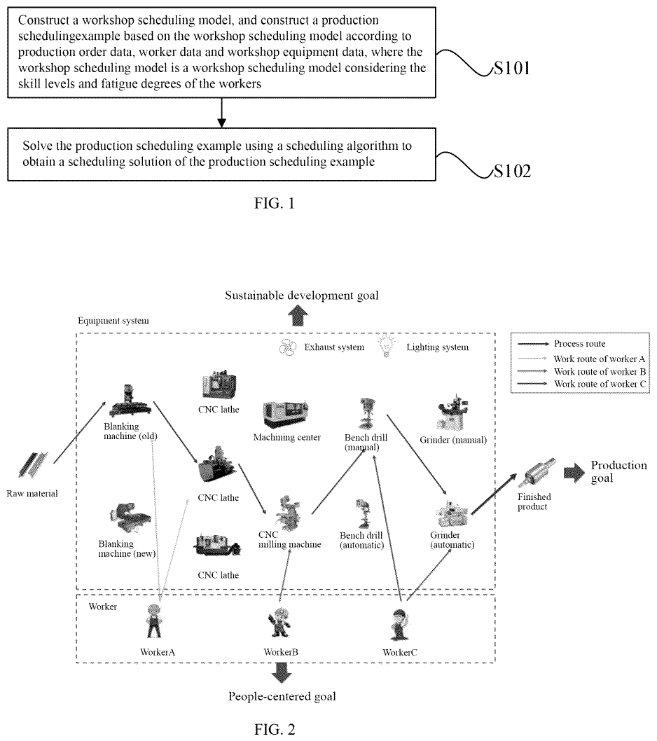

FIG. 1 is a flowchart of a first embodiment of a workshop scheduling method considering skill levels and fatigue degrees of workers provided by the present disclosure. Referring to FIG. 1, the workshop scheduling method provided by the embodiment may include the following steps S101 and S102.

In step S101, a workshop scheduling model is constructed, and a production scheduling example is constructed based on the workshop scheduling model according to production order data, worker data and workshop equipment data, where the workshop scheduling model is a workshop scheduling model considering the skill levels and fatigue degrees of the workers.

Specifically, the workshop scheduling model is configured for constructing a production scheduling example according to workshop data (including production order data, worker data and workshop equipment data), which takes into account the skill levels and fatigue degrees of the workers.

It should be noted that the workshop scheduling model is constructed according to actual needs. FIG. 2 is a schematic diagram of the workshop scheduling model according to an example of the present disclosure. Referring to FIG. 2, the embodiment takes a workshop machining production scenario as an example. The constructed workshop scheduling model may be described as follows: in a production system, there is a set of workpiece tasks J=(J₁, J₂, . . . , Jₙ) composed of m workpieces, and a set of workers W=(W₁, W₂, . . . , W_{w}) composed of W workers processing on a set of machines M=(M₁, M₂, . . . , Mₘ) including m. machines. Each workpiece Jᵢ has a fixed sequence of rᵢ processes OPᵢ=(Oᵢ₁, Oᵢ₂, . . . , Oᵢᵣ), and a process Oᵢⱼ means that a j-th process of the workpiece f can be executed on a machine selected from a specific subset of the set of machines M. Each worker Wₐ has a specific set of skills K_{w}_{ₐ}=(U_{W}_{ₐ}_{, M}_{₁}, U_{W}_{ₐ}_{, M}_{₂}, . . . , U_{W}_{ₐ}_{, M}_{ₘ}), worker skill refers to that the worker has the ability to operate a specific machine, and each worker has a corresponding set of skill levels KL_{W}_{ₐ}=(FUT_{W}_{ₐ}_{, M}_{₁}, FUT_{W}_{ₐ}_{, M}_{₂}, . . . , FUT_{W}_{ₐ}_{, M}_{ₘ}). When an equipment type is automated machining equipment, the skill level is quantified as an initial operation time of the worker Wₐ operating the machine Mₚ. When equipment is human-machine collaborative processing equipment, the skill level is quantified as a proportion of operation time by the worker Wₐ operating the machine Mₚ for the first time that exceeds standard working hours. In each step of processing assignment, the processing task can only be carried out when the workpiece Jᵢ the machine Mₚ and the worker Wₐ are all ready. In other words, the workshop scheduling model may be decomposed into three sub-problems: (1) workpiece selection: determining the processing sequence of workpieces in each batch of processing tasks; (2) machine allocation: determining machine allocation for each operation of each workpiece; and (3) worker assignment: determining the worker operating the machine for each process.

Further, objective functions of the workshop scheduling model include a first objective function for minimizing a total production duration, a second objective function for minimizing carbon emission of the system, and a third objective function for minimizing a standard deviation of worker fatigue; where
the first objective function is as follows:

$${f}_{1} = min {T}^{E} = min ( max {t}_{{O}_{ij}}^{OET} )$$

$${t}_{{O}_{ij}}^{OET} = \{ \begin{matrix}{FUT}_{{W}_{a} , {M}_{p}} \times ( H + ( 1 - H ) \times {x}_{{W}_{a} , {M}_{p}}^{- {φ}_{{W}_{a}}} ) + {t}_{{J}_{i} , {O}_{ij} , {M}_{p}}^{MT} , & {MK}_{m} = 0 \\ {FUT}_{{W}_{a} , {M}_{p}} \times {t}_{{O}_{ij}}^{OET} \times {x}_{{W}_{a} , {M}_{p}}^{- {φ}_{{W}_{a}}} , + {t}_{{J}_{i} , {O}_{ij} , {M}_{p}}^{MT} , & {MK}_{m} = 1\end{matrix}$$

where T^{E} is the total production duration;

$${t}_{{O}_{ij}}^{OET}$$

is a total processing time of the j-th process for the workpiece j; FUT_{W}_{ₐ}_{, M}_{ₚ} is the skill level of a worker Wₐ operating a machine Mₚ; H is an incompressibility coefficient; X_{W}_{ₐ}_{, M}_{ₚ} is the number of times the worker Wₐ operates the machine Mₚ; φWₐ is a learning rate of the worker Wₐ;

$${t}_{{J}_{i} , {O}_{ij} , {M}_{p}}^{MT}$$

is a basic processing time of the j-th process for the workpiece j on the machine Mₚ; and MKₘ, is a machine type;
the second objective function is as follows:

f₂=min C^{E}

C^{E}=C^{AE}+C^{CM}+C^{MR}+C^{TR}+C^{FP}
where C^{E} is the carbon emission of the system; C^{AE} is a total carbon emission from wear and tear of auxiliary processing equipment; C^{CM} is a total carbon emission resulting from the use of processing consumables; C^{MR} is a total carbon emission from the operation of equipment to complete manufacturing tasks in the production system; C^{TR} is an overall carbon emission from transportation during processing; and C^{FP} is a total carbon emission from public equipment in the workshop;
the third objective function is as follows:

$${f}_{3} = min {VF}^{E} = min ( \sqrt{\frac{{\sum }_{a = 1}^{w} {( {f}_{{W}_{a} , t + 1} - \frac{{\sum }_{a = 1}^{w} {f}_{{W}_{a} , t + 1}}{w} )}^{2}}{w}} )$$

f_{W}_{ₐ}_{,t+1}=S_{W}_{ₐ}_{,t}×Rₜ×[1−(1−f_{W}_{_{a,}}ₜ)×e^{-ρW}^{ₐ}]+(1−S_{W}_{ₐ}_{,t})×f_{W}_{_{a,}}ₜ×e^{-ωW}^{ₐ}

where VF^{E} is the standard deviation of worker fatigue; f_{W}_{ₐ}_{, t}+1 is a cumulative fatigue value of the worker Wₐ at the t+1 moment; w is the number of the workers in the production system; S_{W}_{ₐ}ₜ is a decision-making variable of working states of the workers; Rₜ is a workload coefficient defined according to the type of machine operated by the worker; f_{W}_{ₐ}_{, t} is a cumulative fatigue value of the worker Wₐ at the t moment; ρ_{W}_{ₐ} is a fatigue accumulation rate determined by personal physical quality of the worker; and ω_{W}_{ₐ} is a fatigue recovery rate determined by the personal physical quality of the worker;

Constraints of the workshop scheduling model are as follows:

$${\sum }_{p = 1}^{m} {X}_{{J}_{i} , {O}_{ij} , {M}_{p}} = 1 , \qquad ∀ i , j ; i = 1 , … , n ; j = 1 , … , {r}_{i}$$

$${\sum }_{p = 1}^{m} {X}_{{J}_{i} , {O}_{ij} , {W}_{a}} = 1 , \qquad ∀ i , j ; i = 1 , … , n ; j = 1 , … , {r}_{i}$$

$${\sum }_{a = 1}^{w} {U}_{{W}_{a} , {M}_{p}} \geq 1 , \qquad ∀ p ; p = 1 , … , m$$

$${\sum }_{p = 1}^{m} {\sum }_{a = 1}^{w} {U}_{{W}_{a} {M}_{p}} \times {X}_{{J}_{i} , {O}_{ij} , {W}_{a}} = 1 , \qquad ∀ i , j ; i = 1 , … , n ; j = 1 , … , {r}_{i}$$

$$j < k , {t}_{{O}_{ij}}^{OET} \leq {t}_{{O}_{ik}}^{OST} \qquad ∀ i ; i = 1 , … , n$$

where m represents the number of the machines; p. represents the sequence number of a machine; X_{Ji}, Oᵢⱼ, Mₚ represents whether the process Oᵢⱼ for the workpiece Jᵢ is executed on the machine Mₚ; X_{Ji}, OᵢⱼWₐ represents whether the process Oᵢⱼ for the workpiece Jᵢ. is executed by the worker Wₐ; w represents the number of the workers; a represents the sequence number of a worker; U_{W}_{ₐ}_{, M}_{ₚ} represents whether the worker Wₐ has the skill to operate the machine Mₚ; j, k represents the sequence number of a process;

$${t}_{{O}_{ij}}^{OET}$$

represents the processing starting time of the j-th process for the workpiece i; and

$${t}_{{O}_{ij}}^{OET}$$

represents the processing ending time of the j-th process for the workpiece i.

In other words, the constraints of the workshop scheduling model are as follows: ensuring that each process for each workpiece is processed by one and only one machine; ensuring that each process for each workpiece is processed by one and only one worker; ensuring that each machine can be operated by at least one worker; ensuring that the workers can only operate the machines they are skilled at; and ensuring the sequential constraints between processes for each workpiece, that is, the processing starting time of a subsequent process cannot be earlier than the processing ending time of the preceding process.

Further, the production order data include workpiece name, the number of processes, a set of processes, a set of selectable machines for processes, basic processing time for processes on selectable machines, workpiece material, workpiece quality, workpiece yield, and material utilization rate. The worker data include worker name, a set of worker skills, initial operation time of the worker, learning rate, fatigue accumulation rate, and fatigue recovery rate. The workshop equipment data include machine name, human-machine interaction type, no-load power, load power, a set of auxiliary processing equipment, equipment lifespan a set of consumables, consumable usage rate per unit time, and machine location.

In specific implementation, the production order data, the worker data and the workshop equipment data that are acquired and calculated in real time are input into the constructed workshop scheduling model to obtain the production scheduling example.

In step S102, the production scheduling example is solved using a scheduling algorithm to obtain a scheduling solution of the production scheduling example.

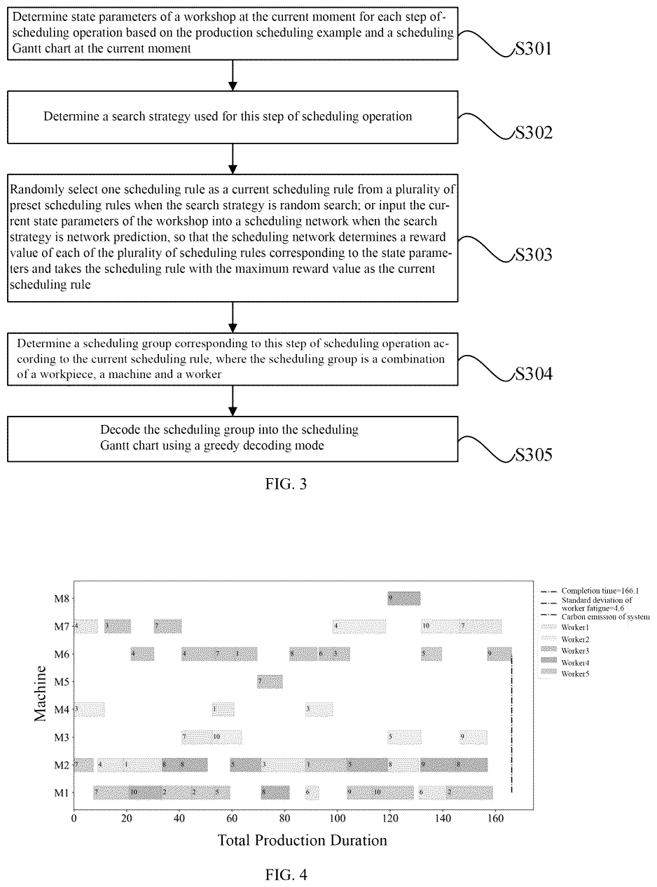

Specifically, the scheduling algorithm is used to solve the production scheduling example, and the scheduling group (a scheduling combination of a workpiece, a machine and a worker) of the workshop is controlled based on the obtained scheduling solution. FIG. 3 is a flowchart of solving the production scheduling example based on the scheduling algorithm according to an example of the present disclosure. Referring to FIG. 3, the process of solving the production scheduling example using the scheduling algorithm may include the following steps S301 and S302.

In step S301, state parameters of the workshop at the current moment are determined for each step of scheduling operation based on the production scheduling example and a scheduling Gantt chart at the current moment.

Specifically, the scheduling Gantt chart is used to visualized the progress and time arrangement of workshop scheduling. FIG. 4 is a schematic diagram of the scheduling Gantt chart according to an example of the present disclosure.

Further, the state parameters represent the states of the workshop (the states of the workpieces, the machines and the workers), and include average workpiece completion rate, standard deviation of workpiece completion rate, expected completion time, total expected emission of the system, standard deviation of emission, average effective working emission rate of machines, standard deviation of effective working emission rate of machines, average fatigue of workers, and standard deviation of worker fatigue.

It should be noted that the state parameters may be normalized state parameters. It can be understood that each state parameter includes a corresponding influence factor. The influence factor for the expected completion time is an average value of the sum of the maximum processing times and the sum of the minimum processing times for all the processes, the influence factor for the expected total emission of the system is the number of the machines, the average processing emission of the machines, the average no-load emission of the machines, and an average value of the sum of the maximum processing times and the sum of the minimum processing times for all the processes, the influence factor for the standard deviation of emission is the total emission of the system under the current state, the influence factor for the average fatigue of workers is an average value of the sum of the maximum processing times and the sum of the minimum processing times for all the processes, and the influence factor for the standard deviation of worker fatigue is the average fatigue of the workers.

The normalized state parameters may be expressed as:

pf=pf^{s}/Πτ

where pf is the normalized state parameters; pf^{s} is the state parameters before normalization; and Πτ is the product of the influence factors corresponding to all the state parameters.

In specific implementation, various state parameters are determined for each step of scheduling operation based on the production scheduling example and the scheduling Gantt chart.

In step S302, a search strategy used in this step of scheduling operation is determined.

Specifically, the search strategy includes random search and network prediction. Specific implementations and implementation processes of random search and network prediction will be described below, which will not be repeated here.

In specific implementation, the search strategy used in this step of scheduling operation may be determined through a ε-greedy strategy. That is, a random number δ is generated, and the relationship between the random number δ and the current ε is judged. If δ is greater than ε, it is determined to use random search. If δ is less than ε, it is determined to use network prediction. It should be noted that ε is set according to actual needs. In the embodiment, the specific value of ε is not limited. For example, in one embodiment, the initial value of ε is 0.80, ε is updated with each iteration, and the value of ε decreases by 0.001 with each iteration.

In step S303, one scheduling rule is randomly selected as a current scheduling rule from a plurality of preset scheduling rules when the search strategy is random search; or the current state parameters of the workshop are input into a scheduling network when the search strategy is network prediction, so that the scheduling network determines a reward value of each of the plurality of scheduling rules corresponding to the state parameters and takes the scheduling rule with the maximum reward value as a current scheduling rule.

Specifically, the plurality of preset scheduling rules are set according to actual needs, which are not limited in the present embodiment. For example, in one embodiment, the plurality of preset scheduling rules include: 1.{FIFO}; 2.{FOFI}; 3.{LPT}; 4.{SPT}; 5.{MCO}; 6.{LTH}; 7.{LCR; LCE; LTW}; 8.{LCR; LCE; SOT}; 9. {LCR; SMT; LTW}; 10. {LCR; SMT; SOT}; 11. {HCR; LCE; LTW}; 12.{HCR; LCE; SOT}; 14.{HCR; SMT; LTW}; and 14. {HCR; SMT; SOT};
where FIFO represents selecting a workpiece-machine-worker scheduling group that can start processing the earliest;
FOFI represents selecting a workpiece-machine-worker scheduling group that can complete processing the earliest;
LPT represents selecting a workpiece-machine-worker scheduling group with the longest processing time;
SPT represents selecting a workpiece-machine-worker scheduling group with the shortest processing time;
MCO represents selecting a workpiece-machine-worker scheduling group that increases the least emission;
LTH represents selecting a workpiece-machine-worker scheduling group that accumulates the most fatigue for the least tired workers;
LCR represents selecting a workpiece with the minimum completion rate;
HCR represents selecting a workpiece with the maximum completion rate;
LCE represents selecting a machine with the minimum carbon emission;
SMT represents selecting a machine with the shortest processing time;
LTW represents selecting a worker with the least current fatigue; and
SOT represents selecting a worker with the shortest operation time.

FIFO, FOFI, LPT, SPT, MCO and LTH are composite heuristic rules, LCR and HCR are workpiece scheduling rules, LCE and SMT are machine scheduling rules, and LTW and SOT are worker scheduling rules.

Optionally, in one possible implementation, the scheduling network is used to determine the current scheduling rule corresponding to the state parameters of the workshop at the current moment, and includes a first model temporal difference deep q-network (TDQN) and a second model advantage deep q-network (ADQN). The first model inputs the state parameters, and outputs a current decision-making tendency under the state parameters. The second model inputs the state parameters and a current decision-making tendency, and outputs the current scheduling rule.

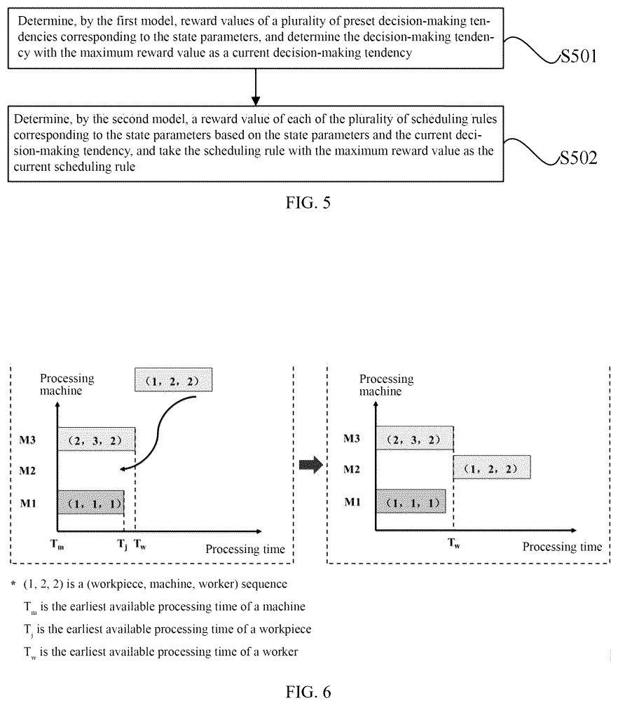

In specific implementation, FIG. 5 is a flowchart of a second embodiment of the workshop scheduling method considering skill levels and fatigue degrees of workers according to an example of the present disclosure. According to the method provided by the present embodiment, on the basis of the above-mentioned embodiments, the scheduling network, when including the first model and the second model, determines a reward value of each of the plurality of scheduling rules corresponding to the state parameters, and takes the scheduling rule with the maximum reward value as the current scheduling rule, including the following steps S501, S502, S304 and S305:

In step S501, the first model determines reward values of a plurality of preset decision-making tendencies corresponding to the state parameters, and determines the decision-making tendency with the maximum reward value as the current decision-making tendency.

Specifically, the plurality of preset decision-making tendencies represent the current optimization goals of the workshop scheduling model, and are set according to actual needs, which are not limited in the present embodiment. For example, in one embodiment, the decision-making tendencies include three values: 0, 1 and 2. The decision-making tendency being 0 represents that the workshop scheduling model tends to optimize the total production duration, the decision-making tendency being 1 represents that the workshop scheduling model tends to optimize the carbon emission of the system, and the decision-making tendency being 2 represents that the workshop scheduling model tends to optimize the standard deviation of worker fatigue.

Further, the reward values of the decision-making tendencies represent the degree of excellence of the decision-making tendencies. The higher the reward value, the greater the likelihood that the decision-making tendency will be determined as the current decision-making tendency.

In specific implementation, the state parameters are input into the first model to obtain the reward values of the state parameters under the plurality of preset decision-making tendencies. Further, the decision-making tendency with the maximum reward value is determined as the current decision-making tendency.

For example, in one embodiment, the state parameters input into the first model are [0.13, 0.21, 0.15, 0.22, 0.31, 0.45, 0.13, 0.61, 0.36] and the determined current decision-making tendency is 0.

In step S502, the second model determines a reward value of each of the plurality of scheduling rules corresponding to the state parameters based on the state parameters and the current decision-making tendency, and takes the scheduling rule with the maximum reward value as the current scheduling rule.

Specifically, the reward value of each scheduling rule represents the degree of the the excellence of the scheduling rule. The higher the reward value, the greater the likelihood that the scheduling rule will be determined as the current scheduling rule. The current scheduling rule is used to indicate that a scheduled group corresponding to this step of scheduling operation is determined according to this scheduling rule.

In specific implementation, the state parameters and the current decision-making tendency are input into the second model to obtain the reward value of each scheduling rule corresponding to the state parameters. Further, the scheduling rule with the maximum reward value is determined as the current scheduling rule.

For example, with reference to the above example, when the input state parameters are [0.13, 0.21, 0.15, 0.22, 0.31, 0.45, 0.13, 0.61, 0.36] and the determined current decision-making tendency is 0, in this step, [0.13, 0.21, 0.15, 0.22, 0.31, 0.45, 0.13, 0.61, 0.36, 0] are input into the second model, and the second model outputs 1, that is, the determined current scheduling rule is FIFO.

In step S304, a scheduling group corresponding to this step of scheduling operation is determined according to the current scheduling rule, where the scheduling group is a combination of a workpiece, a machine and a worker.

Specifically, the scheduling group includes a workpiece, a machine, and a worker, and indicates which worker processes which workpiece on which machine.

In specific implementation, the next workpiece to be processed is determined (based on the priority, deadline, or other constraints of the workpieces) according to the current scheduling rule, and a machine available for processing the workpiece is determined (based on the machine availability, skill requirements, or other factors). Further, a worker is assigned to operate the selected machine to complete the processing of the workpiece (selected based on the skill level of the worker), and the combination of the workpiece, the machine and the worker is determined as the scheduling group corresponding to this step of scheduling operation.

For example, in one embodiment, it is determined that the scheduling group corresponding to this step of scheduling operation is [1, 2, 5], which represents that the worker 5 processes the workpiece 1 on the machine 2.

In step S305, the scheduling group is decoded to the scheduling Gantt chart using a greedy decoding mode.

Specifically, the earliest available processing time of the workpiece, the earliest available processing time of the machine and the earliest available processing of the worker are obtained, and the latest time among these three available processing times is selected as the processing starting time of the scheduling group. Further, according to the total processing time calculation formula in the first objective function, the completion processing time of the scheduling group is determined, completing the decoding of the scheduled group. FIG. 6 is a schematic diagram illustrating the implementation principle of greedy decoding according to an example of the present disclosure. For the specific implementation principle and implementation process of greedy decoding, reference can be made to the description in the related technology, which will not be repeated here.

For example, in one embodiment, with reference to the above example, the start time of the scheduling group is 18.0 if the previous completion processing time of the workpiece 1 is 15.0, the completion time of the previous workpiece processed on the machine 2 is 13.0, and the completion time of the previous processing task carried out by the worker 5 is 18.0. Further, if the calculated total machining time is 8.0, the decoded scheduling group is as follows: The worker 5 processes the workpiece 1 on the machine 2, with the processing task starting at 18.0 and ending at 26.0.

With reference to FIG. 2 and the above description, the scheduling solution is solved for each step of scheduling operation according to FIG. 2 until all scheduling operations are complete. The final output scheduling Gantt chart is a final scheduling solution.

It should be noted that Table 1 shows a comparison of the solving time of the scheduling method in an example of the present disclosure with conventional meta-heuristic algorithms represented by ACO and NSGA-II:

TABLE 1

| | 1 | 2 | 3 | 4 | 5 | 6 | 7 | 8 | 9 | 10 |
|---|---|---|---|---|---|---|---|---|---|---|
| MOACO | 111.03 | 185.52 | 160.88 | 341.05 | 284.59 | 257.57 | 234.14 | 1083.19 | 1490.23 | 893.62 |
| NSGA-II | 89.07 | 132.73 | 100.71 | 255.84 | 209.91 | 206.19 | 197.23 | 602.93 | 819.71 | 428.67 |
| MODDQN | 2.27 | 3.33 | 2.65 | 7.01 | 5.52 | 5.32 | 4.77 | 18.56 | 20.16 | 10.55 |

It can be seen from Table 1 that the method provided by the present disclosure can achieve real-time scheduling solving, greatly improving the solving speed of scheduling solution.

The embodiment provides a method for determining the current scheduling rule using a scheduling network. Through this method, the current scheduling rule can be determined according to the input state parameters based on the network prediction mode, so that the scheduling group can be determined based on the current scheduling rule, thereby controlling workshop scheduling.

According to the method provided by the embodiment, in a first aspect, by constructing the workshop scheduling model and the production scheduling example and solving the production scheduling example through the workshop scheduling model, workshop scheduling is achieved, thereby reasonably allocating effective production resources, optimizing the production process and improving the production efficiency of a workshop. In a second aspect, the skill levels and fatigue degrees of the workers and the carbon emissions of a system are considered during construction of the workshop scheduling model, aiming to reduce the carbon emissions from production while maintaining the production fairness of workers, thereby helping manufacturing enterprises to establish a more scientific and sustainable workshop scheduling model, improving the production efficiency and reducing carbon emissions, which is of great significance for the sustainable development of enterprises. In a third aspect, solving the production scheduling example using different search strategies improves the generalization of scheduling solution, enhances the production benefits of the workshop, and achieves real-time scheduling solving, greatly increasing the solving speed of scheduling solutions, and improving the scheduling speed.

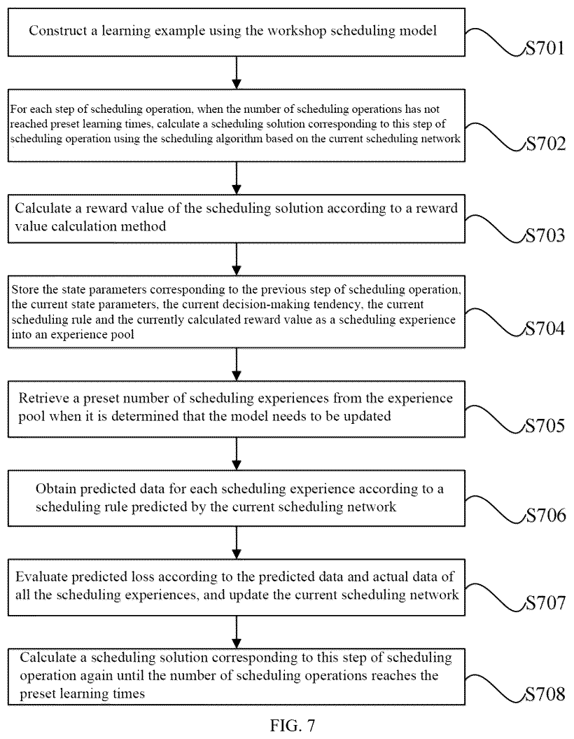

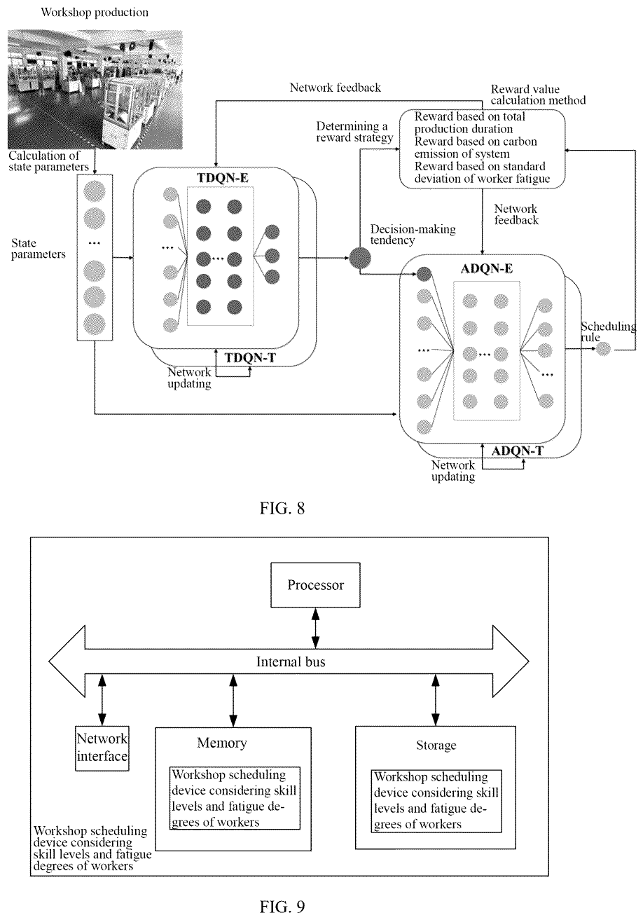

FIG. 7 is a flowchart of a third embodiment of the workshop scheduling method considering skill levels and fatigue degrees of workers provided by the present disclosure. FIG. 8 is a schematic diagram illustrating the implementation principle of training of the scheduling network according to an example of the present disclosure. Referring to FIG. 7 and FIG. 8 simultaneously, the method provided by the present embodiment, based on the above-mentioned embodiments, the training process of the scheduling network includes the following steps S701 to S708.

In step S701, a learning example is constructed using the workshop scheduling model.

Specifically, with reference to the above description, the learning example may be constructed using the workshop scheduling model according to production order data, worker data and workshop equipment data. The production order data include workpiece name, number of processes, a set of processes, a set of selectable machine for processes, basic processing time for processes on selectable machines, workpiece material, workpiece quality, workpiece yield, and material utilization rate; the worker data include worker name, a set of worker skills, initial operation time of the worker, learning rate, fatigue accumulation rate, and fatigue recovery rate; and the workshop equipment data include machine name, human-machine interaction type, no-load power, load power, a set of auxiliary processing equipment, equipment lifespan, a set of consumables, consumable usage rate per unit time, and machine location.

In specific implementation, the production order data, the worker data and the workshop equipment data that are acquired and calculated in real time are input into the workshop scheduling model to obtain the learning example.

In step S702, for each step of scheduling operation, when the number of scheduling operations has not reached preset learning times, the scheduling solution corresponding to this step of scheduling operation is calculated using the scheduling algorithm based on the current scheduling network.

Specifically, the preset learning times are set according to actual needs. In the embodiment, the specific value of the preset learning times is not limited. For example, in one embodiment, the preset learning times are 1,000. The scheduling algorithm is selected according to actual needs, which is not limited in the present embodiment. For example, in one embodiment, the scheduling algorithm is a genetic algorithm.

In specific implementation, the state parameters of the workshop at the current moment are determined for each step of scheduling operation based on the production scheduling example and the scheduling Gantt chart at the current moment. Further, the search strategy used for this step of scheduling operation is determined, and the current scheduling rule is then determined based on the search strategy (when the search strategy is random search, a decision-making tendency is randomly selected as a current decision-making tendency from a plurality of preset decision-making tendencies, and a scheduling rule is randomly selected as the current scheduling rule from a plurality of preset scheduling rules; when the search strategy is network prediction, the current state parameters of the workshop are input into the scheduling network, the scheduling network determines a reward value of each of the plurality of preset decision-making tendencies corresponding to the state parameters, and takes the decision-making tendency with the maximum reward value as a current decision-making tendency, and the scheduling network determines a reward value of each of the plurality of preset scheduling rules corresponding to the state parameters, and takes the scheduling rule with the maximum reward value as the current scheduling rule). Finally, the scheduling solution corresponding to this step of scheduling operation is determined according to the current scheduling rule.

In step S703, the reward value of the scheduling solution is calculated according to a reward value calculation method.

Specifically, the reward value represents the degree of excellence of the scheduling solution. The higher the reward value, the better the scheduling solution, and the greater the production benefits it brings to workshop scheduling.

Further, with reference to the above description, since the objective functions of the workshop scheduling model include the first objective function for minimizing the total production duration, the second objective function for minimizing the carbon emission of the system, and the third objective function for minimizing the standard deviation of worker fatigue, the reward values include rewards in three aspects: the reward based on the total production duration, the reward based on the carbon emission of the system, and the reward based on the standard deviation of worker fatigue.

In specific implementation, the reward value of the scheduling solution is calculated according to the following formula:

$${r}_{y} = \frac{{c}_{y}^{t} \times {r}_{y}^{t} + {c}_{y}^{c} \times {r}_{y}^{c} + {c}_{y}^{h} \times {r}_{y}^{h}}{{c}_{y}^{t} + {c}_{y}^{c} + {c}_{y}^{h}}$$

where r_{y} is the reward value of the scheduling solution;

$${c}_{y}^{t}$$

is a reward coefficient corresponding to a time-based reward corresponding to the y-th step of scheduling operation;

$${r}_{y}^{t}$$

is the time-based reward;

$${c}_{y}^{c}$$

is a reward coefficient corresponding to a carbon emission-based reward corresponding to the y-th step of scheduling operation;

$${r}_{y}^{c}$$

is the carbon emission-based reward;

$${c}_{y}^{h}$$

is a reward coefficient corresponding to a human factor-based reward corresponding to the y-th step of scheduling operation; and

$${r}_{y}^{h}$$

is the human factor-based reward corresponding to the y-th step of scheduling operation.

It should be noted that

$${c}_{y}^{t} , {c}_{y}^{c} and {c}_{y}^{h}$$

will vary according to the decision-making tendency corresponding to the y-th step of scheduling operation. When the decision-making tendency tends to minimize the total production duration,

$${c}_{y}^{t}$$

is set to 0.6, and

$${c}_{y}^{c} and {c}_{y}^{h}$$

are set to 0.2. When the decision-making tendency tends to minimize the carbon emission of the system,

$${c}_{y}^{c}$$

is set to 0.6, and

$${c}_{y}^{t} and {c}_{y}^{h}$$

are set to 0.2. When the decision-making tendency tends to minimize the standard deviation of worker fatigue,

$${c}_{y}^{h}$$

is set to 0.6, and

$${c}_{y}^{t} and {c}_{y}^{h}$$

are set to 0.2.

For example, in one embodiment, if

$${c}_{y}^{t}$$

is 0.6,

$${r}_{y}^{t}$$

is 0.5,

$${c}_{y}^{c} .$$

is 0.2,

$${r}_{y}^{c}$$

is 1.0,

$${c}_{y}^{h}$$

is 0.2, and

$$. {r}_{y}^{h}$$

is −1.0, the calculated reward value of the scheduling solution is 0.3.

In step S704, the state parameters corresponding to the previous step of scheduling operation, the current state parameters, the current decision-making tendency, the current scheduling rule and the currently calculated reward value are stored as a scheduling experience into an experience pool.

In specific implementation, the state parameters corresponding to the previous step of scheduling operation, the current state parameters, the current decision-making tendency, the current scheduling rule and the reward value calculated using the reward value calculation formula are stored as the scheduling experience into the experience pool.

For example, in one embodiment, with reference to the above example, the state parameters corresponding to the previous step of scheduling operation are [0.13, 0.21, 0.15, 0.22, 0.31, 0.45, 0.13, 0.61, 0.36], the current state parameters are [0.15, 0.18, 0.16, 0.23, 0.29, 0.35, 0.15, 0.63, 0.39], the current decision-making tendency is 0, the current scheduling rule is 1, and the currently calculated reward value is 0.3, and then in this step, the scheduling experience stored in the experience pool is [[0.13, 0.21, 0.15, 0.22, 0.31, 0.45, 0.13, 0.61, 0.36], [0.15, 0.18, 0.16, 0.23, 0.29, 0.35, 0.15, 0.63, 0.39], 0, 1, 0.3].

In step S705, a preset number of scheduling experiences are retrieved from the experience pool when it is determined that the model needs to be updated.

Specifically, the preset number is set according to actual needs. In the present embodiment, the specific value of the preset number is not limited. For example, in one embodiment, the preset number is 16.

In specific implementation, every two steps of scheduling operations, it is determined that the model needs to be updated, and at this point, a preset number of scheduling experiences are retrieved from the experience pool. If only one step of scheduling operation is completed, it is determined that the model does not need to be updated, and at this point, the next step of scheduling operation is continued.

For example, in one embodiment, with reference to the above example, every two steps of scheduling operations, 16 pieces of scheduling experiences are retrieved from the experience pool.

In step S706, for each scheduling experience, predicted data are obtained according to the scheduling rule predicted by the current scheduling network.

Specifically, the predicted data include a predicted decision-making tendency, a reward value of the decision-making tendency, a predicted scheduling rule, and a reward value of the scheduling rule.

Specifically, with reference to the above description, for each piece of scheduling experience (including the state parameters corresponding to the previous step of scheduling operation, the current state parameters, the current decision-making tendency, the current scheduling rule and the currently calculated reward value), the current state parameters are input into the current scheduling network to obtain the predicted decision-making tendency, the reward value of the decision-making tendency, the predicted scheduling rule and the reward value of the scheduling rule can be obtained.

In step S707, predicted loss is evaluated according to the predicted data and actual data of all the scheduling experiences, and the current scheduling network is updated.

Specifically, an MES loss function is used to evaluate the predicted loss for the predicted data (including the predicted decision-making tendency, the reward value of the decision-making tendency, the predicted scheduling rule, and the reward value of the scheduling rule) of all the scheduling experiences and the actual data (the current decision-making tendency, the current scheduling rule, and the currently calculated reward value) of all the scheduling experiences and the scheduling network is updated according to evaluation results.

Specifically, referring to FIG. 8, the first model and the second model each consist of an evaluation network and a target network. The evaluation network of the first model is TDQN-E, and the target network is TDQN-T. The evaluation network of the second model is ADQN-E, and the target network is ADQN-T. When the scheduling network is updated, the evaluation networks (i.e. TDQN-E and ADQN-E) in the scheduling network may be updated.

Further, it is determined whether a target network updating rule is satisfied, that is, the weights of the evaluation networks are copied to the target networks every 200 steps of scheduling operations, copying the weight of TDQN-E to TDQN-T and the weight of ADQN-E to AdQN-T.

In step S708, a scheduling solution corresponding to this step of scheduling operation is calculated again until the number scheduling operations reaches the preset learning times.

Specifically, the scheduling solution corresponding to this step of scheduling operation is calculated again based on the method in step S702 until the number of scheduling operations reaches the preset learning times.

For example, with reference to the above example, in this step, the scheduling solution corresponding to this step of scheduling operation is calculated again until the number of scheduling operations reaches 1,000 times.

Specifically, with reference to the foregoing introduction, after 1,000 complete scheduling solutions are completed, learning is completed, and the trained scheduling network is stored.

The embodiment provides a method for training a scheduling network. The scheduling network trained by this method continuously evaluates predicted loss for the predicted data and the actual data and updating according, resulting in a finally trained scheduling network. Subsequently, a production scheduling example can be solved based on this scheduling network, thereby improving the generalization of the scheduling solution, enhancing the production benefit of the workshop, achieving real-time scheduling solving and greatly increasing the solving speed of the scheduling solution.

Corresponding to the aforementioned embodiment of the workshop scheduling method considering skill levels and fatigue degrees of workers, the present disclosure further provides a workshop scheduling device considering skill levels and fatigue degrees of workers.

The embodiment of the workshop scheduling device considering skill levels and fatigue degrees of workers provided by the present disclosure can be applied to workshop scheduling equipment considering skill levels and fatigue degrees of workers. The device embodiment may be implemented by software, hardware, or a combination of both. Taking software implementation as an example, as a device in a logical sense, the device is formed by a processor of the workshop scheduling equipment reading the corresponding computer program instructions from a non-volatile storage into a memory and running them. From the hardware perspective, as shown in FIG. 9, which is a hardware structure diagram of the workshop scheduling equipment considering skill levels and fatigue degrees of workers where the workshop scheduling device considering skill levels and fatigue degrees of workers provided by the present disclosure is located. In addition to the processor, memory, network interface and non-volatile storage shown in FIG. 9, the workshop scheduling equipment where the device is located in the embodiment may also include other hardware according to the actual function of the workshop scheduling device, which will not be elaborated herein.

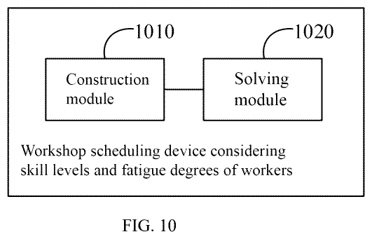

FIG. 10 is a schematic structural diagram of a first embodiment of the workshop scheduling device considering skill levels and fatigue degrees of workers provided by the present disclosure. Referring to FIG. 10, the device provided by the embodiment includes a construction module 1010 and a solution module 1020.

The construction module 1010 is configured for constructing a workshop scheduling model and constructing a production scheduling example based on the workshop scheduling model according to production order data, worker data and workshop equipment data, where the workshop scheduling model is a workshop scheduling model considering the skill levels and fatigue degrees of the workers.

The solution module 1020 is configured for solving the production scheduling example using a scheduling algorithm to obtain a scheduling solution of the production scheduling example.

Solving the production scheduling example using the scheduling algorithm includes the following steps:
state parameters of a workshop at the current moment are determined for each step of scheduling operation based on the production scheduling example and a scheduling Gantt chart at the current moment;
a search strategy used for this step of scheduling operation is determined;
one scheduling rule is randomly selected as the current scheduling rule from a plurality of preset scheduling rules when the search strategy is random search; or, the current state parameters of the workshop are input into a scheduling network when the search strategy is network prediction, so that the scheduling network determines a reward value of each of the plurality of scheduling rules corresponding to the state parameters and takes the scheduling rule with the maximum reward value as the current scheduling rule;
a scheduled group corresponding to this step of scheduling operation is determined according to the current scheduling rule, where the scheduled group is a combination of a workpiece, a machine and a worker; and
the scheduled group is decoded to the scheduling Gantt chart using a greedy decoding mode.

According to the device provided by the embodiment, in a first aspect, by constructing the workshop scheduling model and the production scheduling example and solving the production scheduling example through the workshop scheduling model, workshop scheduling is achieved, thereby reasonably allocating effective production resources, optimizing the production process and improving the production efficiency of a workshop. In a second aspect, the skill levels and fatigue degrees of the workers and the carbon emissions of a system are considered during construction of the workshop scheduling model, aiming to reduce the carbon emissions from production while maintaining the production fairness of the workers, thereby helping manufacturing enterprises to establish a more scientific and sustainable workshop scheduling model, improving the production efficiency and reducing carbon emissions, which is of great significance for the sustainable development of enterprises. In a third aspect, solving the production scheduling example using different search strategies improves the generalization of scheduling solution, enhances the production benefits of the workshops, and achieves real-time scheduling solving, greatly increasing the solving speed of scheduling solutions, and improving the scheduling speed.

The device of the embodiment can be used to execute the steps of the method embodiment shown in FIG. 1, and the specific implementation principle and implementation process are similar, which will not be repeated here.

Continuing to refer to FIG. 9, the present disclosure further provides workshop scheduling equipment considering skill levels and fatigue degrees of workers, including a memory, a processor, and a computer program stored in the storage and capable of running on the processor, where the program, when executed by the processor, implements the steps of any one of the methods provided by the first aspect of the present disclosure.

The present disclosure further provides a computer-readable storage medium storing a computer program, where the program, when executed by a processor, implements the steps of any one of the methods provided by the present disclosure.

The implementation process of the function and role of each unit in the above-mentioned device are described in detail in the implementation process of the corresponding steps in the above-mentioned method, which will not be repeated here.

For the device embodiment, since it basically corresponds to the method embodiment, related parts can refer to the descriptions in the method embodiment. The above-described device embodiment is merely illustrative, and the units described as separated components may or may not be physically separated. The components shown as units may or may not be physical units, that is, they may be located at one place or distributed across a plurality of network units. Part or all of the modules may be selected according to actual needs to achieve the purposes of the solution of the present disclosure. Those skilled in the art can understand and implement the present disclosure without making creative efforts.

The above descriptions are merely preferred embodiments of the present disclosure, and are not intended to limit the present disclosure. Any modifications, equivalent replacements, improvements, etc., made within the spirit and principle of the present disclosure shall fall within the protection scope of the present disclosure.

What is claimed:

1. A workshop scheduling method considering skill levels and fatigue degrees of workers, comprising:
constructing a workshop scheduling model, and constructing a production scheduling example based on the workshop scheduling model according to production order data, worker data and workshop equipment data, wherein the workshop scheduling model is a workshop scheduling model considering the skill levels and fatigue degrees of the workers; and
solving the production scheduling example using a scheduling algorithm to obtain a scheduling solution of the production scheduling example;
wherein solving the production scheduling example using the scheduling algorithm comprises:
determining state parameters of a workshop at the current moment for each step of scheduling operation based on the production scheduling example and a scheduling Gantt chart at the current moment;
determining a search strategy used for this step of scheduling operation;
randomly selecting one scheduling rule as a current scheduling rule from a plurality of preset scheduling rules when the search strategy is random search; or inputting the current state parameters of the workshop into a scheduling network when the search strategy is network prediction, so that the scheduling network determines a reward value of each of the plurality of scheduling rules corresponding to the state parameters and takes the scheduling rule with the maximum reward value as the current scheduling rule;
determining a scheduling group corresponding to this step of scheduling operation according to the current scheduling rule, wherein the scheduling group is a combination of a workpiece, a machine and a worker; and
decoding the scheduled group to the scheduling Gantt chart using a greedy decoding mode;
wherein the scheduling network comprises a first model and a second model, and determining, by the scheduling network, a reward value of each of the plurality of scheduling rules corresponding to the state parameters, and taking the scheduling rule with the maximum reward value as the current scheduling rule comprise:
determining, by the first model, reward values of a plurality of preset decision-making tendencies corresponding to the state parameters, and determining the decision-making tendency with the maximum reward value as a current decision-making tendency; and
determining, by the second model, a reward value of each of the plurality of scheduling rules corresponding to the state parameters based on the state parameters and the current decision-making tendency, and taking the scheduling rule with the maximum reward value as the current scheduling rule.

2. The method according to claim 1, wherein the training process of the scheduling network comprises:
constructing a learning example using the workshop scheduling model;
for each step of scheduling operation, when the number of scheduling operations has not reached preset learning times, calculating a scheduling solution corresponding to this step of scheduling operation using the scheduling algorithm based on the current scheduling network;
calculating a reward value of the scheduling solution according to a reward value calculation method;
storing the state parameters corresponding to the previous step of scheduling operation, the current state parameters, the current decision-making tendency, the current scheduling rule and the currently calculated reward value as a scheduling experience into an experience pool;
retrieving a preset number of scheduling experiences from the experience pool when it is determined that the model needs to be updated;
obtaining predicted data for each scheduling experience according to a scheduling rule predicted by the current scheduling network;
evaluating predicted loss according to the predicted data and actual data of all the scheduling experiences, and updating the current scheduling network; and
calculating a scheduling solution corresponding to this step of scheduling operation again until the number of scheduling operations reaches the preset learning times.

3. The method according to claim 2, wherein calculating the reward value of the scheduling solution comprises:
calculating the reward value of the scheduling solution according to the following formula:
$${r}_{y} = \frac{{c}_{y}^{t} \times {r}_{y}^{t} + {c}_{y}^{c} \times {r}_{y}^{c} + {c}_{y}^{h} \times {r}_{y}^{h}}{{c}_{y}^{t} + {c}_{y}^{c} + {c}_{y}^{h}}$$
wherein r_{y} is the reward value of the scheduling solution;
$${c}_{y}^{t}$$
is a reward coefficient corresponding to a time-based reward corresponding to the y-th step of scheduling operation;
$${r}_{y}^{t}$$
is the time-based reward;
$${c}_{y}^{c}$$
is a reward coefficient corresponding to a carbon emission-based reward corresponding to the y-th step of scheduling operation;
$${r}_{y}^{c}$$
is the carbon emission-based reward;
$${c}_{y}^{h}$$
is a reward coefficient corresponding to a human factor-based reward corresponding to the y-th step of scheduling operation; and
$$. {r}_{y}^{h}$$
is the human factor-based reward corresponding to the y-th step of scheduling operation.

4. The method according to claim 1, wherein the plurality of preset scheduling rules comprises: {FIFO}, {FOFI}, {LPT}, {SPT}, {MCO}, {LTH}, {LCR, LCE, LTW}, {LCR, LCE, SOT}, {LCR, SMT, LTW}, {LCR, SMT, SOT}, {HCR, LCE, LTW}, {HCR, LCE, SOT}, {HCR, SMT, LTW}, and {HCR, SMT, SOT};
wherein FIFO represents selecting a workpiece-machine-worker scheduling group that can start processing the earliest;
FOFI represents selecting a workpiece-machine-worker scheduling group that can complete processing the earliest;
LPT represents selecting a workpiece-machine-worker scheduling group with the longest processing time;
SPT represents selecting a workpiece-machine-worker scheduling group with the shortest processing time;
MCO represents selecting a workpiece-machine-worker scheduling group that increases the least emission;
LTH represents selecting a workpiece-machine-worker scheduling group that accumulates the most fatigue for the least tired workers;
LCR represents selecting a workpiece with the minimum completion rate;
HCR represents selecting a workpiece with the maximum completion rate;
LCE represents selecting a machine with the minimum carbon emission;
SMT represents selecting a machine with the shortest processing time;
LTW represents selecting a worker with the least current fatigue; and
SOT represents selecting a worker with the shortest operation time.

5. The method according to claim 1, wherein the workshop scheduling model is as follows: in a production system, there is a set of workpiece tasks J=(J₁, J₂, . . . , Jₙ) composed of n workpieces, and a set of workers W=(W₁, W₂, . . . , W_{w}) composed of w workers processing on a set of machines M=(M₁, M₂, . . . , Mₘ) comprising m machines; each workpiece Jᵢ has a fixed sequence of rᵢ processes OPᵢ=(Oᵢ₁, Oᵢ₂, . . . , Oᵢᵣ), and a process Oᵢⱼ means that a j-th process for a workpiece i can be executed on a machine selected from a specific subset of the set of machines M; each worker Wₐ has a specific set of skills K_{W}_{ₐ}=(U_{W}_{ₐ}_{, M}_{₁}, U_{W}_{ₐ}_{, M}_{₂}, . . . , U_{W}_{ₐ}_{, M}_{ₘ}) worker skill refers to that the worker has the ability to operate a specific machine, and each worker has a corresponding set of skill levels KL_{W}_{ₐ}=(FUT_{W}_{ₐ}_{, M}_{₁}, FUT_{W}_{ₐ}_{, M}_{₂}, . . . , FUT_{W}_{ₐ}_{, M}_{ₘ}) when an equipment type is automated machining equipment, the skill level is quantified as an initial operation time of the worker Wₐ operating a machine Mₚ; when equipment is human-machine collaborative processing equipment, the skill level is quantified as a proportion of operation time by the worker Wₐ operating the machine Mₚ for the first time that exceeds standard working hours; and in each step of processing assignment, the processing task can only be carried out when the workpiece Jᵢ, the machine Mₚ and the worker Wₐ are all ready.

6. The method according to claim 5, wherein objective functions of the workshop scheduling model include a first objective function for minimizing a total production duration, a second objective function for minimizing carbon emission of the system, and a third objective function for minimizing a standard deviation of worker fatigue; wherein
the first objective function is as follows:
$${f}_{1} = min {T}^{E} = min ( max {t}_{{O}_{ij}}^{OET} )$$
$${t}_{{O}_{ij}}^{OET} = \{ \begin{matrix}{FUT}_{{W}_{a} , {M}_{p}} \times ( H + ( 1 - H ) \times {x}_{{W}_{a} , {M}_{p}}^{- {φ}_{{W}_{a}}} ) + {t}_{{J}_{i} , {O}_{ij} , {M}_{p}}^{MT} , & {MK}_{m} = 0 \\ {FUT}_{{W}_{a} , {M}_{p}} \times {t}_{{O}_{ij}}^{OET} \times {x}_{{W}_{a} , {M}_{p}}^{- {φ}_{{W}_{a}}} , + {t}_{{J}_{i} , {O}_{ij} , {M}_{p}}^{MT} , & {MK}_{m} = 1\end{matrix}$$
wherein T^{E} is the total production duration;
$${t}_{{O}_{ij}}^{OET}$$
is a total processing time of the j-th process for the workpiece i; FUT_{W}_{ₐ}_{, M}_{ₚ}, is the skill level of a worker Wₐ operating a machine Mₚ; H is an incompressibility coefficient; X_{W}_{ₐ}_{, M}_{ₚ} is the number of times the worker Wₐ operates the machine Mₚ; φ_{W}_{ₐ} is a learning rate of the worker Wₐ;
$${t}_{{J}_{i} , {O}_{ij} , {M}_{p}}^{MT}$$
is a basic processing time of the j-th process for the workpiece i on the machine Mₚ; and MKₘ is a machine type;
the second objective function is as follows:
$${f}_{2} = min {C}^{E}$$
$${C}^{E} = {C}^{AE} + {C}^{CM} + {C}^{MR} + {C}^{TR} + {C}^{FP}$$
wherein C^{E} is the carbon emission of the system; C^{AE} is a total carbon emission from wear and tear of auxiliary processing equipment; C^{CM} is a total carbon emission resulting from the use of processing consumables; C^{MR} is a total carbon emission from operation of equipment to complete manufacturing tasks in the production system; C^{TR} is an overall carbon emission from transportation during processing; and C^{FP} is a total carbon emission from public equipment in the workshop;
the third objective function is as follows:
$${f}_{3} = min {VF}^{E} = min ( \sqrt{\frac{{\sum }_{a = 1}^{w} {( {f}_{{W}_{a} , t + 1} - \frac{{\sum }_{a = 1}^{w} {f}_{{W}_{a} , t + 1}}{w} )}^{2}}{w}} )$$
f_{W}_{ₐ}_{,t+1}=S_{W}_{ₐ}_{,t}×Rₜ×[1−(1−f_{W}_{_{a,}}ₜ)×e^{-ρW}^{ₐ}]+(1−S_{W}_{ₐ}_{,t})×f_{W}_{_{a,}}ₜ×e^{-ωW}^{ₐ}
wherein VF^{E} is the standard deviation of worker fatigue; f_{W}_{ₐ}_{, t+1} is a cumulative fatigue value of the worker Wₐ at the t+1 moment; w is the number of the workers in the production system; S_{W}_{ₐ}_{, t} is a decision-making variable of working states of the workers; Rₜ is a workload coefficient defined according to the type of machine operated by the worker; f_{W}_{ₐ}_{, t} is a cumulative fatigue value of the worker Wₐ at the t moment; τWₐ is a fatigue accumulation rate determined by personal physical quality of the worker; and ω_{W}_{ₐ} is a fatigue recovery rate determined by the personal physical quality of the worker; and
the constraints of the workshop scheduling model comprise: ensuring that each process for each workpiece is processed by one and only one machine; ensuring that each process for each workpiece is processed by one and only one worker; ensuring that each machine can be operated by at least one worker; ensuring that the workers can only operate the machines they are skilled at; and ensuring that the sequential constraints between the processes for each workpiece, that is, the processing start time of a subsequent process cannot be earlier than the processing end time of the preceding process.

7. A workshop scheduling device considering skill levels and fatigue degrees of workers, comprising a construction module and a solving module, wherein
the construction module is configured for constructing a workshop scheduling model and constructing a production scheduling example based on the workshop scheduling model according to production order data, worker data and workshop equipment data, wherein the workshop scheduling model is a workshop scheduling model considering the skill levels and fatigue degrees of the workers; and
the solving module is configured for solving the production scheduling example using a scheduling algorithm to obtain a scheduling solution of the production scheduling example;
wherein solving the production scheduling example using the scheduling algorithm comprising:
determining state parameters of a workshop at the current moment for each step of scheduling operation based on the production scheduling example and a scheduling Gantt chart at the current moment;
determining a search strategy used for this step of scheduling operation;
randomly selecting one scheduling rule as the current scheduling rule from a plurality of preset scheduling rules when the search strategy is random search; or inputting the current state parameters of the workshop into a scheduling network when the search strategy is network prediction, so that the scheduling network determines a reward value of each of the plurality of scheduling rules corresponding to the state parameters and takes the scheduling rule with the maximum reward value as the current scheduling rule;
determining a scheduling group corresponding to this step of scheduling operation according to the current scheduling rule, wherein the scheduled group is a combination of a workpiece, a machine and a worker; and
decoding the scheduled group to the scheduling Gantt chart using a greedy decoding mode;
wherein the scheduling network comprises a first model and a second model, and determining, by the scheduling network, the reward value of each of the plurality of scheduling rules corresponding to the state parameters, and taking the scheduling rule with the maximum reward value as the current scheduling rule comprise:
determining, by the first model, reward values of a plurality of preset decision-making tendencies corresponding to the state parameters, and determining the decision-making tendency with the maximum reward value as a current decision-making tendency; and
determining, by the second model, a reward value of each of the plurality of scheduling rules corresponding to the state parameters based on the state parameters and the current decision-making tendency, and taking the scheduling rule with the maximum reward value as the current scheduling rule.

8. (canceled)

9. (canceled)
